(19) United States
(12) Patent Application Publication
(10) Pub. No.: US 2018/0213955 A1
(43) Pub. Date: Aug. 2, 2018

(54) Ergonomic Vessel

(71) Applicant: Making Modern LLC, Lyons, CO (US)

(72) Inventor: Jon Reeves McLaughlin, Lyons, CO (US)

(21) Appl. No.: 15/887,788

(22) Filed: Feb. 2, 2018

Related U.S. Application Data
(60) Provisional application No. 62/453,721, filed on Feb. 2, 2017.

(51) Int. Cl. A47G 19/22

(52) U.S. Cl. CPC A47G 19/2261; B25G 1/102; A47G 19/2255

(57) ABSTRACT

A vessel has a monolithic body forming a container with a top opening into a cavity capable of containing liquids and solids and a stand positioned at the bottom of the container. The container being formed with inwardly, from, bottom to top, sloping outer side surfaces and the stand forming a plurality of apertures positioned adjacent the container. The stand also acts as part of an ergonomic grip for a user of the vessel and is sized and shaped to fit within the top opening such that one vessel is stackable on another.

### RELATED APPLICATIONS

This application claims priority to U.S. Patent Application Ser. No. 62/453,721, titled “Ergonomic Vessel”, filed Feb. 2, 2017, and incorporated herein by reference.

### BACKGROUND

Drinking vessels, such as mugs and glasses, are traditionally round where the bottom of a portion containing the liquid is flat such that the mug/glass stands upright on a flat horizontal surface.

### SUMMARY OF THE INVENTION

In one embodiment, a monolithic body forms a container with a top opening into a cavity capable of containing liquids and solids and a stand at the bottom of the container. The container has inwardly, from bottom to top, sloping outer-side surfaces and the stand forms a plurality of apertures to facilitate drainage when inverted, and acts to provide an ergonomic grip for a user of the vessel.

### BRIEF DESCRIPTION OF THE FIGURES

FIG. 1 is a top front perspective view of a set of four different sized ergonomic square vessels, in an embodiment.

FIG. 2 is a top front perspective showing one square vessel of FIG. 1 in a further exemplary embodiment.

FIG. 3 is a bottom front perspective showing the square vessel of FIGS. 1 and 2 in further exemplary detail, in an embodiment.

FIG. 4 shows a user's hand holding the square vessel of FIGS. 1, 2 and 3, in an embodiment.

FIG. 5 is a front elevation of the square vessel of FIGS. 1, 2 and 3.

FIG. 6 is a vertical cut-away view of the square vessel of FIGS. 1, 2, 3 and 4, showing a thermal cavity within the wall of the body portion, in an embodiment.

FIG. 7 is a top front perspective view of a set of four different sized ergonomic triangular vessels, in an embodiment.

FIG. 8 is a top front perspective view of a set of four different sized ergonomic round vessels, in an embodiment.

### DETAILED DESCRIPTION OF THE EMBODIMENTS

Conventional ceramic mugs have a flat bottom and a handle that projects away from the body of the mug. This handle, while essential for holding the mug because the main body of the mug rapidly conducts heat to and from any cold or hot liquid contained therein and is therefore uncomfortable to hold without using the handle, is also a weakness. The handle protrudes from the main body and is easily broken, and is not particularly comfortable to hold. For example, the shape and position of the handle requires that the user's hand be angled unnaturally when drinking from the mug, and requires that a strong grip be used to prevent the mug from slipping. These conventional cylindrical mugs are not stackable and the handle prevents close positioning together. These ceramic mugs are also fragile, chipping easily when coming into contact with other objects (e.g., other ceramic mugs), and is easily broken if dropped. The user, aware of such vulnerability, must use caution when using and cleaning the mug.

A modern mug, as disclosed herein, overcomes these problems by providing the user with a more convenient, usable, and ergonomically comfortable and practical design. The modern mug is not easily damaged and is therefore less stressful to use than the conventional ceramic mug.

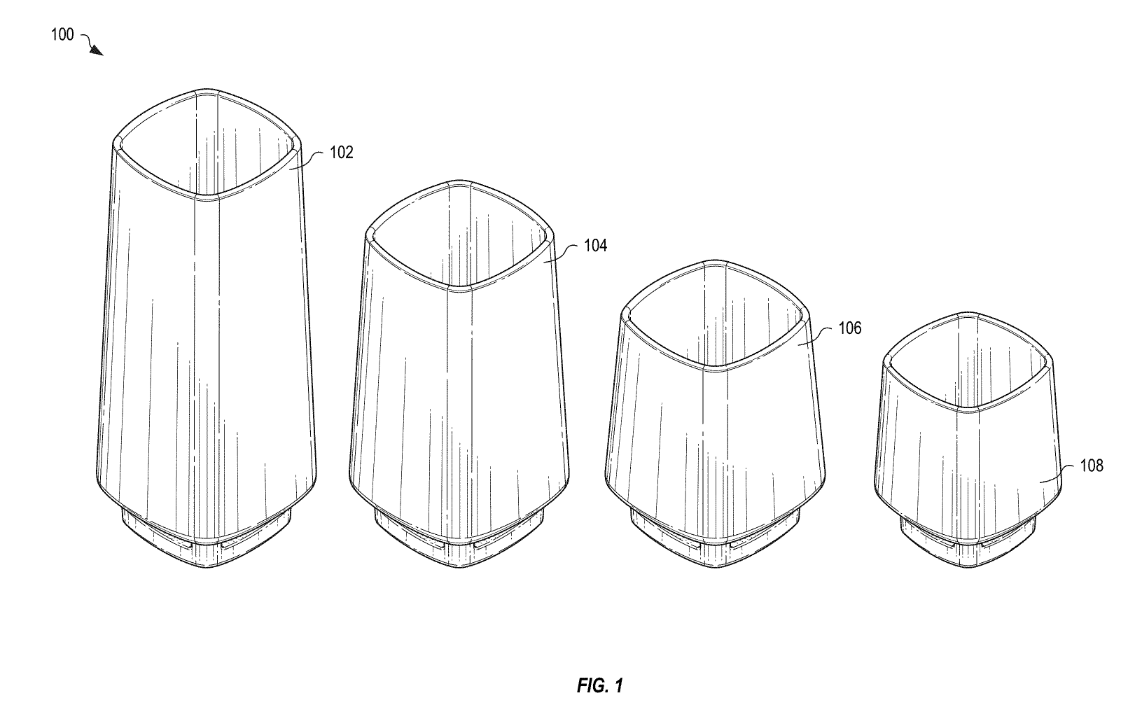

FIG. 1 is a top front perspective view of a set 100 of four different sized ergonomic square vessels 102, 104, 106, and 108 that represent a “modern mug” that overcomes the inefficiencies and impracticalities of the conventional mug. These modern mugs have multiple uses for containing and presenting both liquids and solids. In one embodiment, square vessels 102, 104, 106, and 108 have internal capacities of 16 fl. oz., 12 fl. oz., 8 fl. oz., and 4 fl. oz., respectively. Such sizing is particularly useful for baristas for example. Square vessels 102, 104, 106, and 108 are drinking vessels in an important embodiment.

Vessels 102, 104, 106, and 108 are constructed from a durable material, such that if any one of vessels 102, 104, 106, and 108, is dropped, it does not break. In one embodiment, the durable material is suitable for food and drink and is a Polybutylene terephthalate (PBT), such as Ultradur(R) from BASF. The PBT is formed of seventy percent plastic and thirty percent glass; however, the PBT may have between sixty to eighty percent plastic and between a corresponding forty to twenty percent glass. Vessels 102, 104, 106, and 108 are formed by injection molding from pelleted material for example. Vessels 102, 104, 106, and 108 may be made of other materials and combinations without departing from the scope hereof. The use of PBT makes vessels 102, 104, 106, and 108 incredibly durable. In one test, a vessel was dropped onto asphalt from a height exceeding thirty feet and did not break. In another test, a vessel was dropped over a fifty foot rocky cliff, and did not break. In yet another test, a vessel was driven over by a tire of a sports utility vehicle, and did not break.

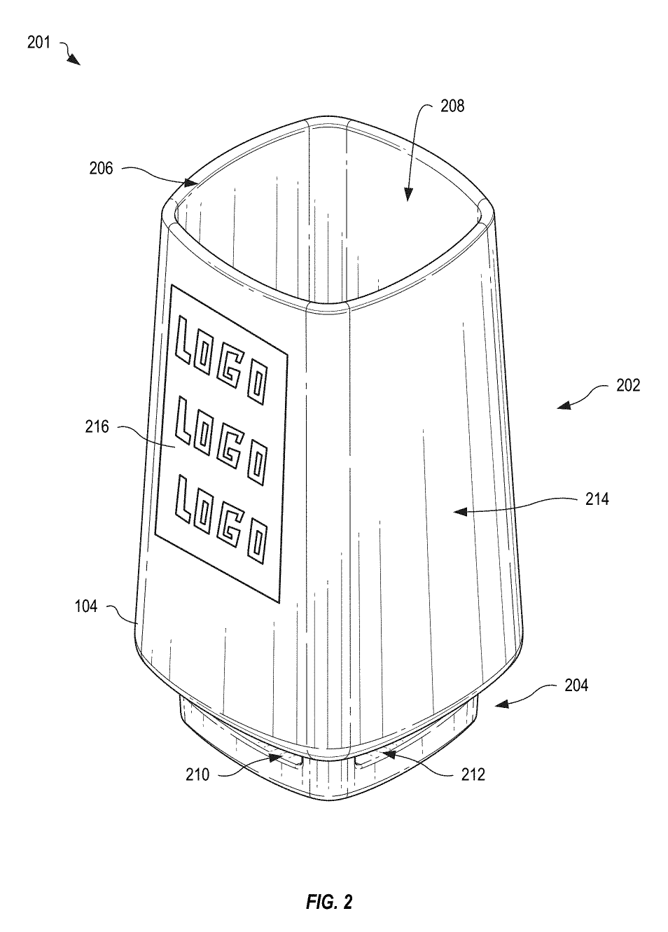

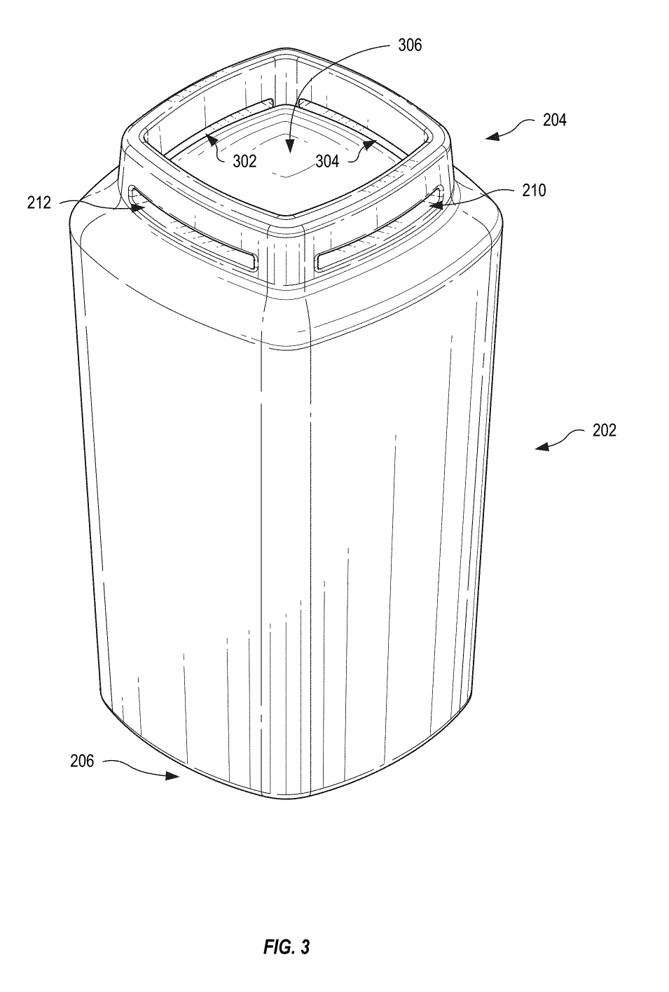

FIG. 2 shows square vessel 104 of FIG. 1 in further exemplary detail. Other square vessels 102, 106 and 108 have similar features corresponding to their size. FIG. 3 is a bottom front perspective showing square vessel 104 of FIGS. 1 and 2 in further exemplary detail. FIGS. 2 and 3 are best viewed together with the following description. Square vessel 104 is a monolithic body 201 forming a container 202 and a stand 204. Container 202 and stand 204 each have a horizontal cross-sectional shape that is a substantially square with rounded corners. Container 202 forms a top opening 206 into a cavity 208 capable of containing liquids and solids. Stand 204 forms a plurality of slit shaped apertures 210, 212, 302, 304 that allow liquid to drain from within stand 204 when square vessel 104 is inverted (e.g., within a dishwasher). Draining of liquid from within stand 204 when square vessel 104 is inverted is further facilitated by a convex outer surface 306 of container 202 within stand 204.

Since container 202 is substantially square, an outer side surface 214 of each side is substantially flat and well suited for receiving text or graphics 216 for display by square vessel 104. Particularly, the flatter outer side surface 214 (as compared to traditional round vessels) allows text or graphics 216 to be read from a wider viewing angle without requiring the vessel to be rotated to see the entire text or graphic 216. Optionally, each vessel 102, 104, 106, and 108 may have a detachable lid (not shown) to reduce heat transfer to and from items within container 202 and to prevent and/or reduce spillage therefrom when vessels 102, 104, 106, and 108 are moved.

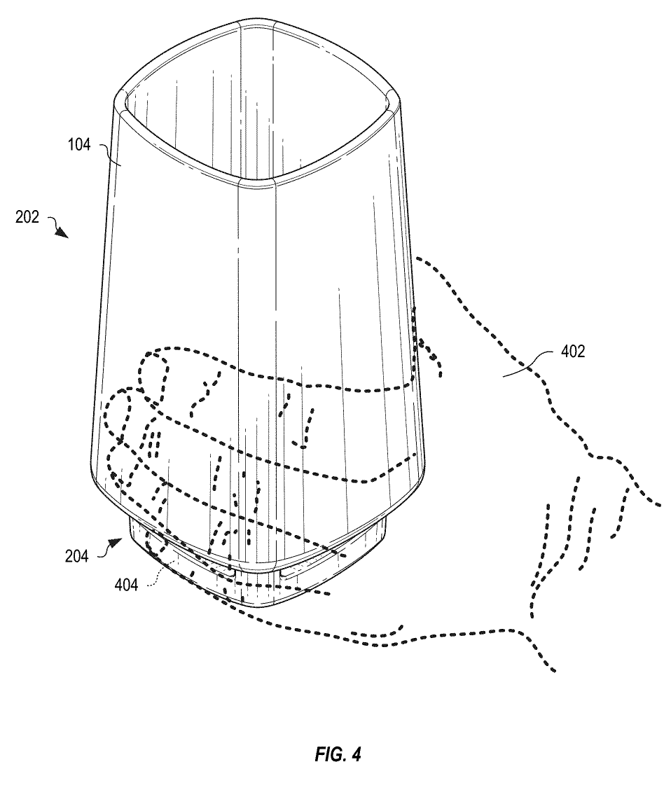

FIG. 4 shows a person's hand 402 holding square vessel 104 of FIGS. 1, 2 and 3. Stand 204 is sized to provide a more comfortable grip for holding vessel 104, since a person's small finger 404 comfortably and naturally positions itself below container 202 and against stand 204, thereby preventing vessel 104 from dropping vertically through hand 402. This grip provides significantly more comfort and control of vessel 104 by the person since their hand has a better position and a more natural grip and relationship to vessel 104, which is better balanced within the hand.

Vessels 102, 104, 106, and 108 are stackable, where stand 204 fits within top opening 206. For example, vessels 104, 106, and 108 are stackable, vessel 108 stacks within the top opening of vessel 102, and vessel 102 stacks within the top opening of vessels 102, 106, and 108.

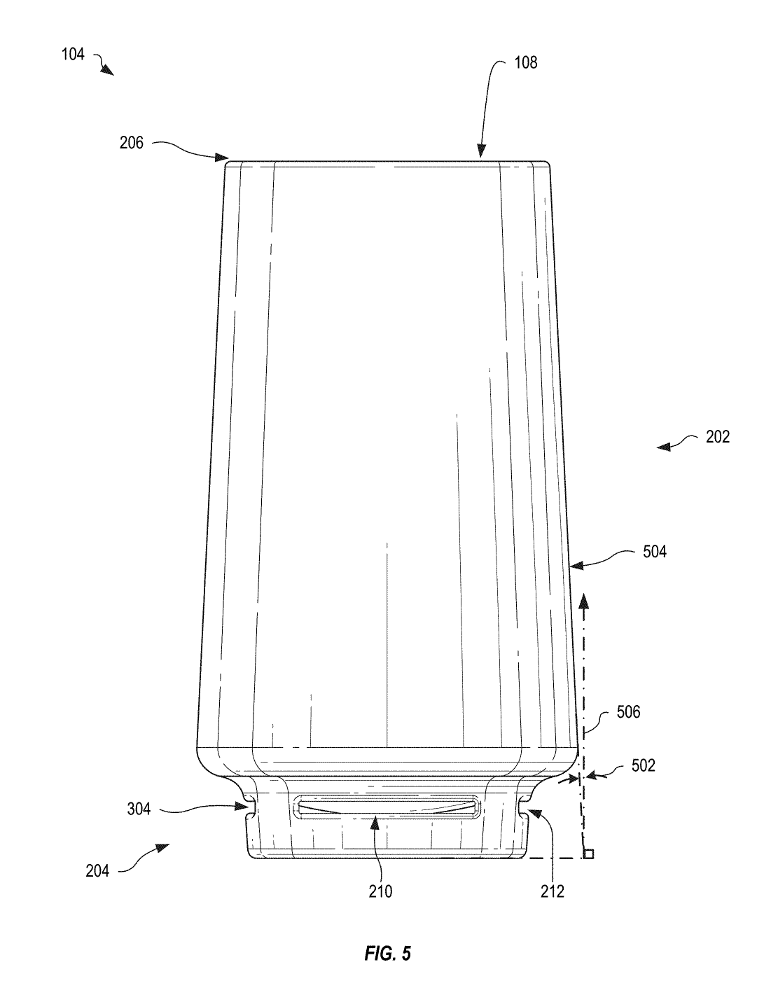

FIG. 5 is a front elevation of square vessel 104 of FIGS. 1, 2, 3 and 4. An angle 502 between outer side surface 504 of container 204 of square vessel 104 and a vertical line 506 shows that outer side surface 504 slopes inwards from bottom to top, which improves viewing (as compared to conventional vertical walled or outward sloping walled vessels) of text or graphics 216 by a person when square vessel 104 is standing on a flat surface that is below eye height of the person (e.g., as when vessel 104 is standing on a table that the person is sitting at, such that the person looks down to vessel 104).

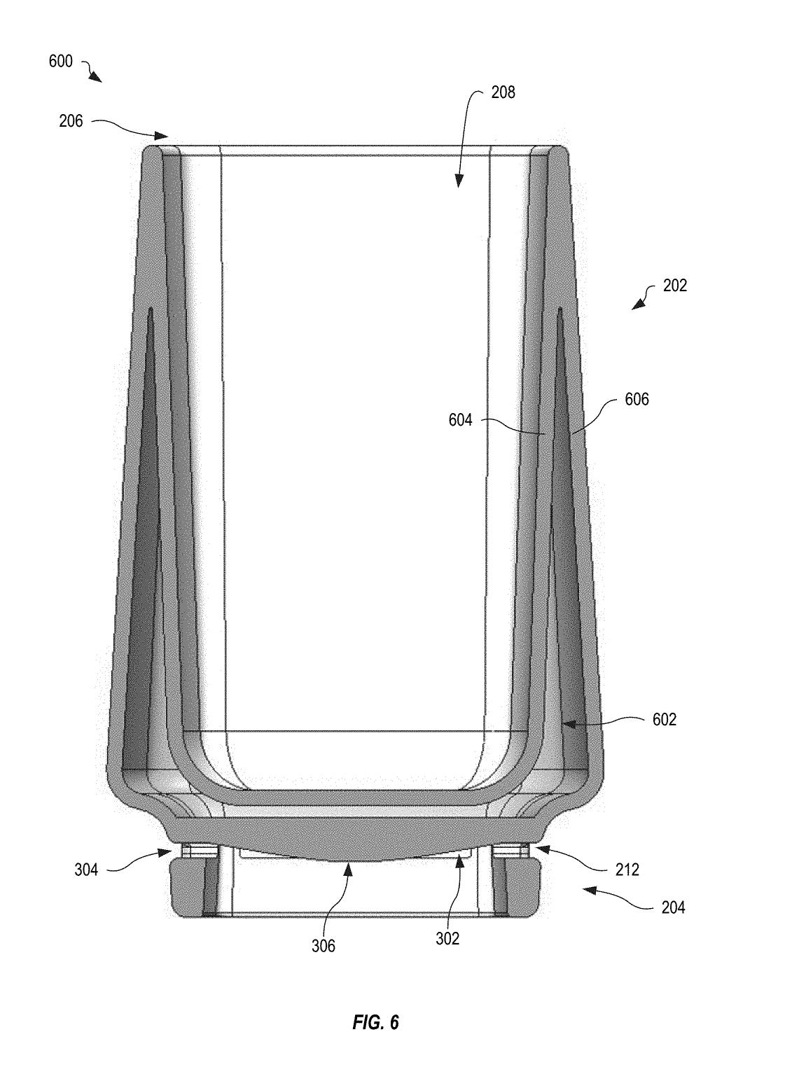

FIG. 6 is a vertical cut-away view 600 of the square vessel 104 of FIGS. 1, 2, 3, 4 and 5, showing a thermal cavity 602 between an inner wall 604 and an outer wall 606 of at least part of container 204. Thermal cavity 602 reduces transfer of thermal energy (i.e., heat) between cavity 208 and the outside of square vessel 104. For example, this helps retain heat of hot liquids within cavity 208, and reduces warming of cold liquids within cavity 208. Further, thermal cavity 602 reduces transfer to heat to and from a person's hand holding square vessel 104, thereby improving comfort of the person. More particularly, as shown in FIG. 6, thermal cavity 602 has greater thickness at the bottom of container 204, where a hand of the person holding vessel 104 is positioned (e.g., see FIG. 4) for the most comfort, thus thermal cavity 602 provides additional thermal comfort where needed most.

In certain embodiments, container 204 of certain of vessels 102, 104, 106, and 108, (i.e., for certain sizes) has a single wall (i.e., a solid wall) that does not include thermal cavity 602. However, since the wall has a greater thickness at the bottom, the hand of the person holding the vessel still benefits from substantial insulation provided by the material itself

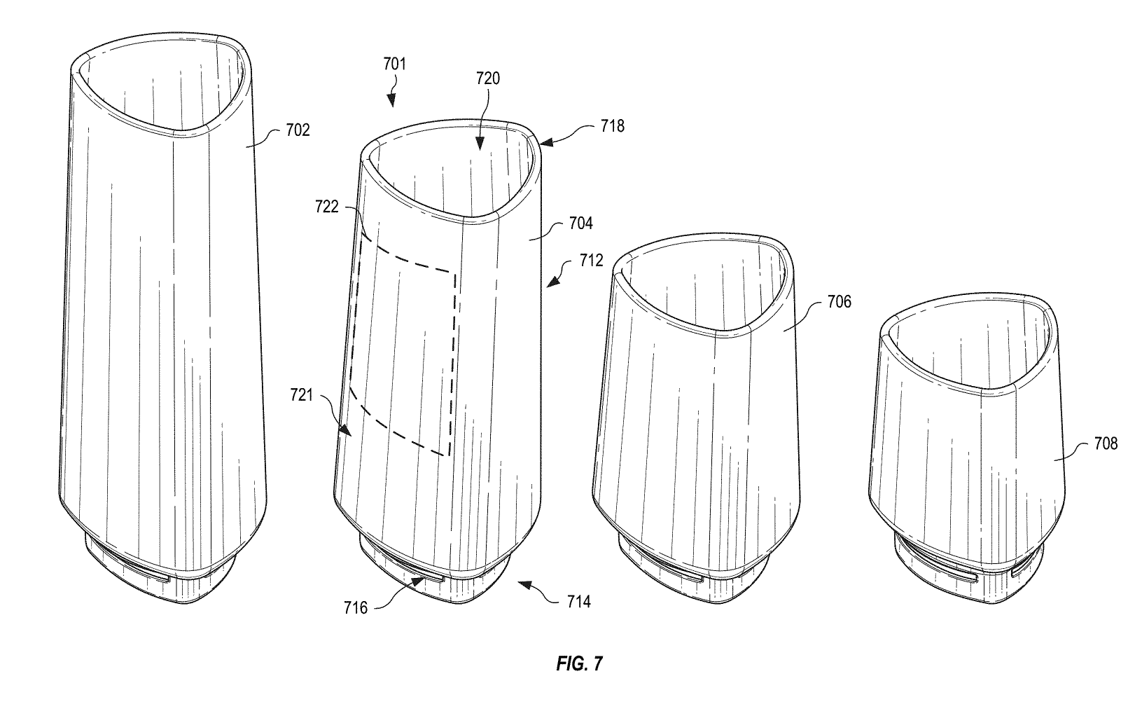

FIG. 7 is a top front perspective view of a set of four different sized ergonomic triangular vessels 702, 704, 706, 708 that have similar features to vessels 102, 104, 106, and 108 of FIGS. 1-6. Triangular vessels 702, 704, 706, and 708 are drinking vessels in an important embodiment. Each vessel 702, 704, 706, and 708 has a monolithic body 701 forming a container 712 and a stand 714. Container 712 and stand 714 each have a horizontal cross-sectional shape that is a substantially triangular with rounded corners. Stand 714 includes three apertures 716 (only one aperture 716 of each vessel is visible in FIG. 7), in view of the triangular cross section, that are similar in position and function to apertures 210, 212, 302 and 304 of vessel 104. Container 712 forms a top opening 718 into a cavity 720 capable of containing liquids and solids.

Outer side surfaces 721 of each vessel 702, 704, 706, 708, are inwardly sloping from bottom to top and are substantially flat for improved visibility of any text or graphic (illustratively represented as dashed outline 722) positioned on outer side surface(s) 721. Walls of each vessel 702, 704, 706, 708 may be solid, or may include a thermal cavity similar to thermal cavity 602 of FIG. 6.

Stand 714 is sized to provide a more comfortable grip for holding vessels 702, 704, 706, 708, since a person's small finger comfortably and naturally positions itself below container 712 and against stand 714, thereby preventing vessels 702, 704, 706, 708 from dropping vertically through the person's hand.

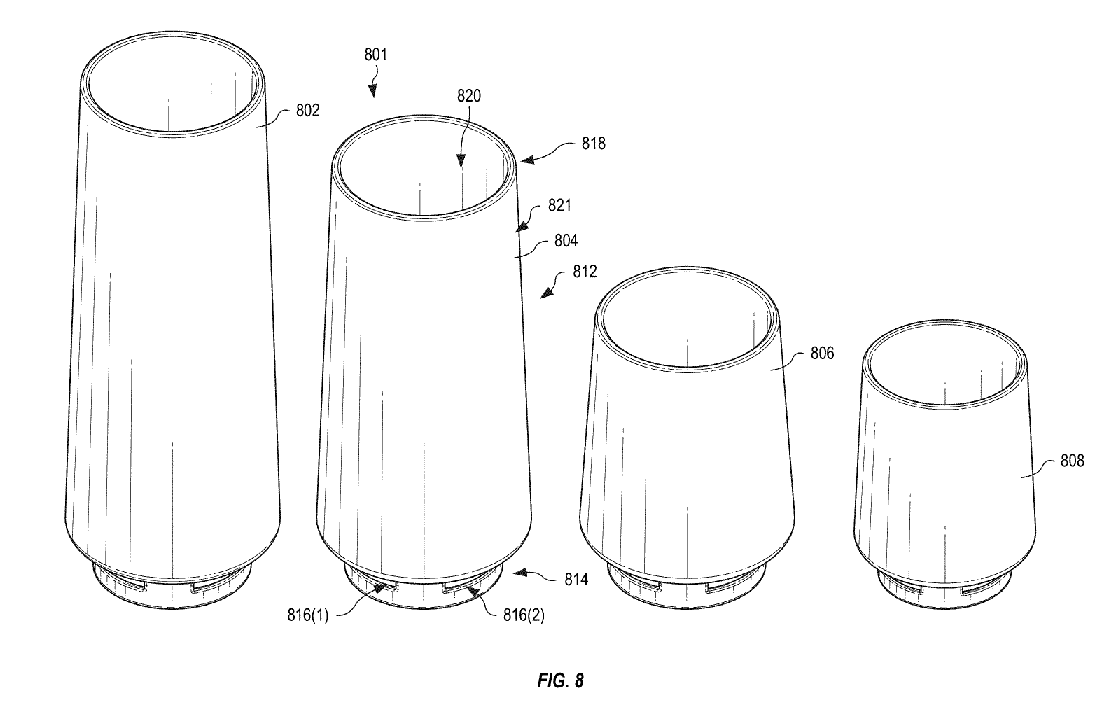

FIG. 8 is a top front perspective view of a set of four different sized ergonomic round vessels 802, 804, 806, and 808 that have certain similar features to vessels 102, 104, 106, and 108 of FIGS. 1-6. Round vessels 802, 804, 806, and 808 are drinking vessels in an important embodiment. Each vessel 802, 804, 806, and 808 has a monolithic body 801 forming a container 812 and a stand 814. Container 812 and stand 814 each have a horizontal cross-sectional shape that is a substantially round. Stand 814 includes four apertures 816 (only two apertures 816 of each vessel are visible in FIG. 8) that are similar in position and function to apertures 210, 212, 302 and 304 of vessel 104. Container 812 forms a top opening 818 into a cavity 820 capable of containing liquids and solids.

Outer side surfaces 821 of each vessel 802, 804, 806, 808, are inwardly sloping from bottom to top. Walls of each vessel 802, 804, 806, 808 may be solid, or may include a thermal cavity similar to thermal cavity 602 of FIG. 6.

Stand 814 is sized to provide a more comfortable grip for holding vessels 802, 804, 806, 808 since a person's small finger comfortably and naturally positions itself below container 812 and against stand 814, thereby preventing vessels 802, 804, 806, 808 from dropping vertically through the person's hand.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. An ergonomic vessel, comprising:
a monolithic body forming:
a container having a top opening into a cavity capable of containing liquids and solids, the container formed with inwardly sloping outer side surfaces; and
a stand positioned at the bottom of the container and forming a plurality of apertures positioned adjacent the body portion.

2. The vessel of claim 1, each of the container and the stand having a horizontal cross sectional shape selected from the group including square, triangular, and round.

3. The vessel of claim 1, the container having walls forming, at least in part, a thermal cavity.

4. The vessel of claim 3, the thermal cavity being greater in thickness towards the bottom of the container.

5. The vessel of claim 1, the stand being sized and positioned relative to the container to allow a person holding the vessel in one hand to position a little finger of the hand adjacent the stand potion and beneath the container such that the vessel is held more securely and more comfortably as compared to a vessel without the stand.

6. The vessel of claim 1, the container having at least one substantially flat outer side surface suitable for displaying a graphic that is readable from a wider viewing angle as compared to graphics on a rounded surface of a conventional vessel.

7. The vessel of claim 6, the outer side surface being inwardly sloping from bottom to top to improve readability of the graphic from a view point higher than the vessel.

8. The vessel of claim 1, the container having a convex surface shape within the stand portion.

9. The vessel of claim 8, the apertures and the convex surface shape cooperating to drain liquid from the stand when the vessel is inverted.

10. The vessel of claim 1, the stand being sized and shaped to fit within the top opening such that the vessel is stackable.

11. The vessel of claim 1, the monolithic body being formed by injection molding of a Polybutylene terephthalate (PBT) material.

12. The vessel of claim 11, the PBT material being formed of seventy percent plastic and thirty percent glass.

13. The vessel of claim 11, the PBT material being formed of between sixty to eighty percent plastic and between a corresponding forty to twenty percent glass.

14. The vessel of claim 11, the monolithic body being durable and not breaking when dropped from a height of thirty feet onto asphalt, dropped from a fifty foot rocky cliff, or driven over by a tire of a sports utility vehicle.
